(19) United States
(12) Patent Application Publication
(10) Pub. No.: US 2006/0294551 A1
(43) Pub. Date: Dec. 28, 2006

(54) Vehicle entertainment system

(76) Inventor: Norman D. Cholewinsky, Eugene, OR (US)

Correspondence Address: KOLISCH HARTWELL, P.C., 200 PACIFIC BUILDING, 520 SW YAMHILL STREET, PORTLAND, OR, 97204, US

(21) Appl. No.: 11/183,287

(22) Filed: Jul. 14, 2005

Related U.S. Application Data
(63) Continuation of application No. 09/369,756, filed on Aug. 6, 1999, now abandoned.
(60) Provisional application No. 60/095,727, filed on Aug. 7, 1998.

(51) Int. Cl. H04N 7/18

(52) U.S. Cl. 725/75; 725/77

(57) ABSTRACT

An onboard vehicle entertainment system is for use within a passenger compartment of a vehicle. The system includes an audio/video signal generator including an onboard wireless transmitter configured for placement within the passenger compartment of the vehicle to produce a vehicle-specific audio/video signal with an audio signal and a video signal component. An audio receiver also forms part of the system and is configured for placement within the passenger compartment of the vehicle, the is adapted for wireless receipt and presentation of the audio signal component transmitted by the onboard transmitter. The system also includes a video receiver configured for placement within the passenger compartment of the vehicle, and the video receiver is adapted for wireless receipt and display of the video signal component transmitted by the onboard transmitter.

### CROSS-REFERENCE TO RELATED APPLICATIONS

This application is a continuation of U.S. patent application Ser. No. 09/369,756, filed Aug. 6, 1999 and entitled “Vehicle Entertainment System”, which application claims priority from U.S. Provisional Patent Application Ser. No. 60/095,727, filed Aug. 7, 1998 and entitled “Vehicle Entertainment System”.

### TECHNICAL FIELD

The present invention relates generally to entertainment systems, and more particularly, to a vehicle entertainment system which effects wireless communication between remote onboard components thereof.

### BACKGROUND ART

For many years now, vehicles have been provided with entertainment systems, typically onboard audio components or the like. Such systems initially were relatively modest, taking the form of dash-mounted AM radios which were relatively simple to install. More recently, however, vehicles have been fitted with increasingly complex entertainment systems, sometimes involving both audio and visual user interface. For example, a “full service” entertainment system may include an AM/FM stereo, a TV tuner, a video cassette player (VCP), a video display, audio speakers and various other audio/video components.

These components may be mounted together, as a unit, but more typically are mounted remotely from one another. A system's video display, for example, may be ceiling-mounted so as to provide for optimal viewing by vehicle occupants. However, a VCP typically is mounted beneath a vehicle seat in order to enhance safety and preserve vehicle cabin space. Despite the remote positioning of these components, it will be understood that they must communicate with one another during system operation.

Until now, communication between the various entertainment system components has involved complex wiring schemes characterized by wiring bundles which run throughout the vehicle. These wiring bundles complicate installation of the entertainment system, and may be aesthetically objectionable to vehicle occupants. It therefore would be desirable to provide an entertainment system which provides for “full-service” entertainment of vehicle occupants with a minimum of additional wiring. It also would be desirable to provide a system which is minimally intrusive, and which is simple to install.

### BRIEF DESCRIPTION OF THE DRAWINGS

FIG. 1 is a schematic view of an entertainment system constructed in accordance with the present invention.

FIG. 2 is a schematic diagram depicting an audio/video signal generator which forms a part of the entertainment system shown in FIG. 1.

FIG. 3 is a schematic diagram of a display unit which forms a part of the entertainment system shown in FIG. 1.

FIG. 4 is a schematic diagram of a headphone set which forms a part of the entertainment system shown in FIG. 1.

FIG. 5 is a schematic diagram depicting an audio receiver unit which forms a part of the entertainment system shown in FIG. 1.

FIG. 6 is a somewhat schematic front view of a control panel which forms a part of the entertainment system shown in FIG. 1.

FIG. 7 is a somewhat schematic front view of an auxiliary control panel which forms a part of the entertainment system shown in FIG. 1.

### DETAILED DESCRIPTION OF A PREFERRED EMBODIMENT AND BEST MODE FOR CARRYING OUT THE INVENTION

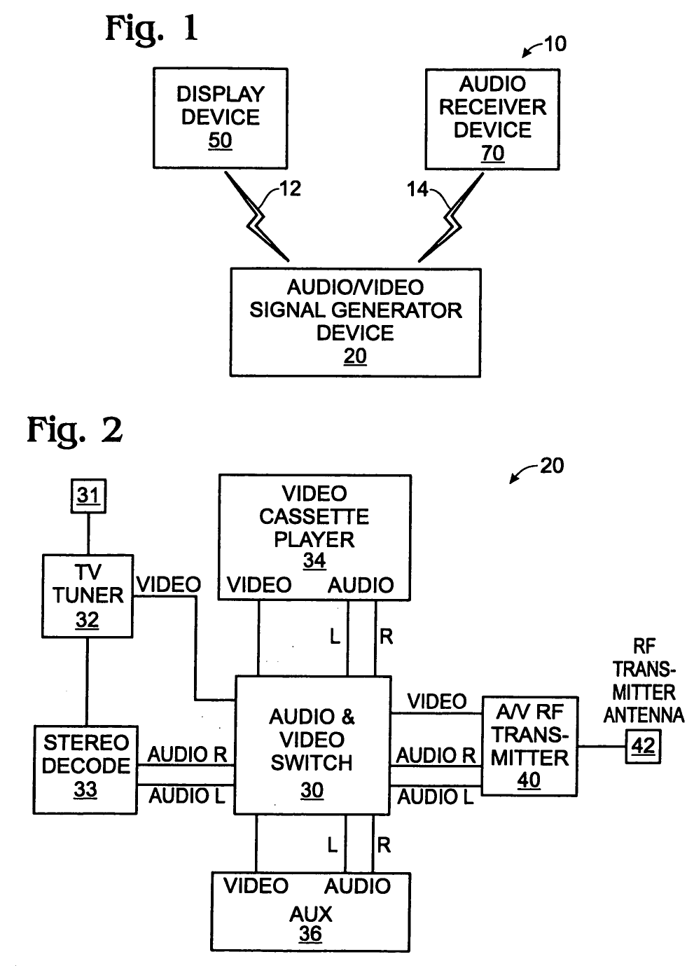

A vehicle entertainment system is shown generally at 10 in FIG. 1, such system being constructed in accordance with the present invention to provide both audio and visual interface to occupants of a vehicle.

The entertainment system includes an audio/video signal generator 20, which generates an audio/video signal for communication to an onboard user interface. The signal generator utilizes wireless communication technology to communicate with various other onboard components, including a display unit 50, a headphone set 60, and an audio receiver unit 70. Communication occurs over wireless communication channels 12, 14, such channels typically being suited for RF communication as will be described below. Although not shown in FIG. 1, it is to be understood that the system also may include various other audio/video components, any number of which may be linked by wireless communication channels.

Referring now to FIG. 2, it will be noted that the signal generator may include several audio/video components, each of which is capable of generating an audio/video signal. Signal generator 20, for example, includes a TV Tuner 32, a Video Cassette Player (VCP) 34, and an Audio/Video Auxiliary device 36. TV Tuner 32 is a conventional broadcast television tuner, the tuner being provided with an antenna 31 and a stereo decoder 33. The components are connected to an Audio & Video Switch 30 via conduits such as coaxial cable, but may be so connected via fiber-optic cable, or any other suitable communication channel.

As indicated, each component provides a video input and audio inputs (typically left and right channels) to the Audio & Video Switch 30. Audio & Video Switch 30 selects from the various audio/video inputs, and provides corresponding video and audio output signals to an A/V RF Transmitter 40. Transmitter 40 produces an RF signal for transmission to one or more user interfaces via RF Transmitter Antenna 42. Those skilled will appreciate that, although an RF transmitter is depicted, other suitable wireless communication transmission devices may be employed.

Signal generator 20 typically is positioned on the floor of a the vehicle with the various audio/video components accessible to the vehicle's occupants. More typically still, the unit is mounted beneath the driver's seat of an automobile for access by rear-seat passengers. It will be understood, however, that the signal generator may be mounted virtually anywhere within the vehicle. Furthermore, the audio/video components may be mounted together in a single location, or may be mounted remotely from one another throughout the vehicle. Remote mounting of the audio/video components, it will be appreciated, may enhance accessibility of the components, and may conserve space.

FIG. 3 depicts user interface in the form of a display unit 50, such display unit being mounted remotely from the signal generator for viewing by vehicle occupants. The display unit includes a Video RF Receiver 52 configured to receive RF signals from signal generator 20 via antenna 51. The display unit also includes an FED Display 54 which presents a video image to the vehicle occupants. The display unit typically is mounted on the vehicle ceiling for viewing by rear-seat passengers. Alternatively, the display device may be mounted to a vehicle console, or within a vehicle seat.

Due to the remote nature of the display device, the audio/video signal is communicated from the signal generator to the display device over a wireless communication channel. The signal may be coded, or the system shielded to avoid interference from audio/video signals of similar units. Alternatively, such interference may be avoided by limiting signal strength, or other suitable interference avoidance techniques.

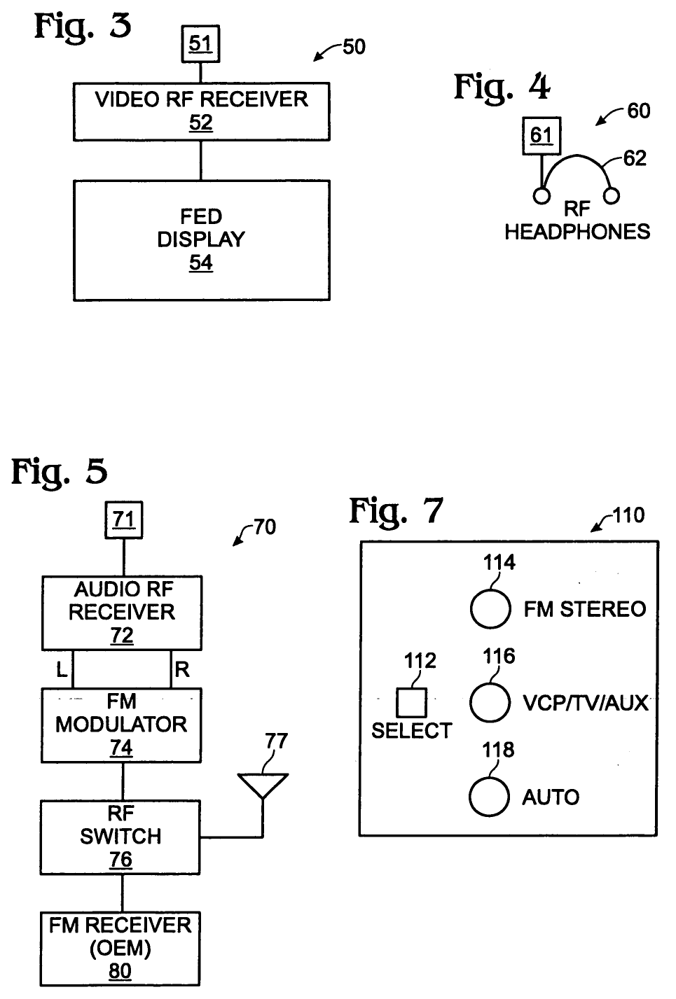

FIG. 4 depicts an audio receiver unit in the form of a headphone set 60 which receives audio/video signals transmitted by the signal generator. As indicated, headphone set 60 include a headphone headset 62 which receives audio/video signals via an antenna 61. The headset may be worn by vehicle occupants so as to provide an individualized audio signal to each vehicle occupant. Headphone set 60 thus may be considered to serve as an audio receiver unit.

Another audio receiver unit is shown at 70 in FIG. 5, such audio receiver unit typically taking the form of a dash-mounted stereo receiver. As indicated, audio receiver unit 70 includes an Audio RF Receiver 72 which receives signals from the signal generator via antenna 71. Audio RF receiver 72, in turn, produces left and right audio signals for communication to FM modulator 74. The FM modulator communicates an output signal to RF Switch 76, which is connected to a speaker 77. As indicated, an FM receiver 80 also may be included the FM Receiver typically taking the form of original equipment installed by the vehicle manufacturer.

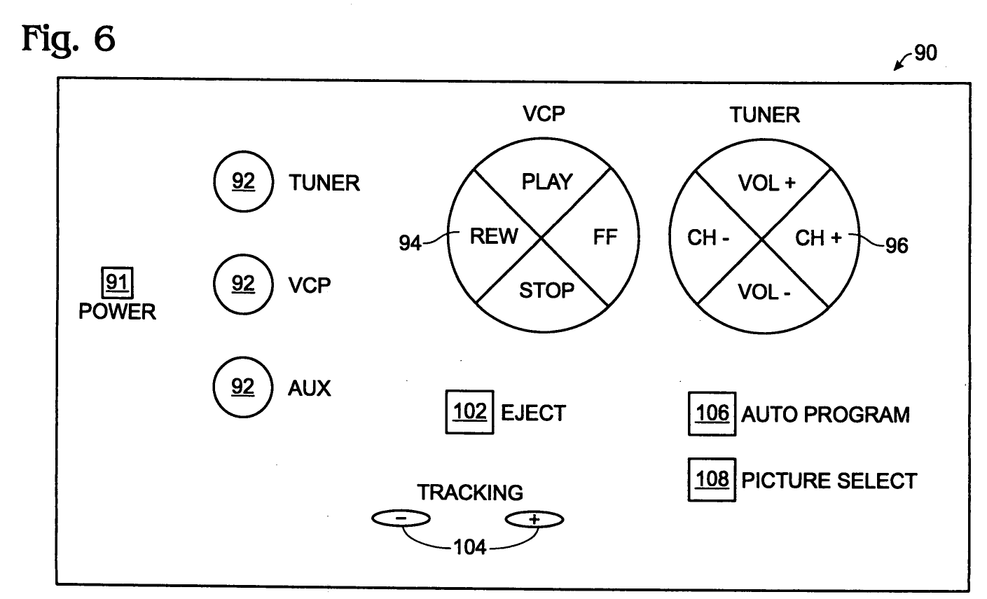

Referring to FIG. 6, a video control panel 90 is depicted, such panel typically being mounted on the in a location accessible to the vehicle occupants. It may be mounted, for example, on the signal generator, on the display unit, on the audio receiver unit, or on a console such as the vehicle dash.

As indicated, control panel 90 includes a power switch 91 which activates the entertainment system. The control panel also may include signal indicators 92 which indicate which component is providing the audio/video signal transmitted by the signal generator. In the depicted embodiment, there are three indicator lights, one indicating that the TV Tuner is in use, one indicating that the VCP is in use, and one indicating that the Audio/Video Auxiliary device is in use.

Control panel 90 also includes a VCP control pad 94 which is provided to allow vehicle occupants to readily effect operational commands such as FF (fast-forward), REW (rewind), PLAY, and STOP. These commands are commonly available on VCP components. A tuner control pad 96 similarly provides vehicle occupants with the ability to readily effect operational commands such as VOL+ (increase volume), VOL− (decrease volume), CH+ (increase channel) and CH− (decrease channel). Additional controls also are provided, including Eject button 102, Tracking buttons 104, Auto Program button 106, and Picture Select button 108.

FIG. 7 depicts a selector panel 110 which provides for selection between various audio/video functions. Although not specifically indicated, selector panel may form a part of control panel 90, or may be mounted remotely. The selector panel includes a Select switch 112 which allows occupants to select among an FM stereo function 114, a VCP/TV/Aux function 116, and an auto function 118.

While the invention has been disclosed in its preferred form, it is to be understood that the specific embodiment thereof as disclosed and illustrated herein is not to be considered in a limiting sense. Numerous variations are possible and that no single feature, function, or property of the preferred embodiment is essential.

I claim:

1. An onboard vehicle entertainment system configured for use within a passenger compartment of a vehicle, the entertainment system comprising:
an audio/video signal generator including an onboard transmitter configured for placement within the passenger compartment of the vehicle to produce a vehicle-specific audio/video signal with an audio signal and a video signal component, the transmitter being adapted for wireless transmission of such audio and video signal components;
an audio receiver configured for placement within the passenger compartment of the vehicle, the audio receiver being adapted for wireless receipt and presentation of the audio signal component transmitted by the onboard transmitter; and
a video receiver configured for placement within the passenger compartment of the vehicle, the video receiver being adapted for wireless receipt and display of the video signal component transmitted by the onboard transmitter.

2. The entertainment system of claim 1, wherein the passenger compartment of the vehicle shields the audio receiver and the video receiver from interference due to audio/video signals exterior to the vehicle.

3. The entertainment system of claim 1, wherein the audio/video signal is coded, the audio receiver being configured to receive, decode and present only desired audio signal components, and the video receiver being configured to received decode and display only desired video signal components.

4. The entertainment system of claim 1, wherein the audio/video signal is an RF signal.

5. The entertainment system of claim 1, wherein the audio/video signal is an IR signal.

6. The entertainment system of claim 1, where in the audio receiver is a AM/FM radio.

7. The entertainment system of claim 1, wherein the audio receiver is a headset.

8. The entertainment system of claim 1, wherein the video receiver is an LCD display.
